(19) United States
(12) Patent Application Publication
(10) Pub. No.: US 2015/0350637 A1
(43) Pub. Date: Dec. 3, 2015

(54) ELECTRONIC APPARATUS AND DISPLAY PROCESSING METHOD

(71) Applicant: KABUSHIKI KAISHA TOSHIBA, Tokyo (JP)

(72) Inventor: Akihiko NOGUCHI, Tokyo (JP)

(73) Assignee: KABUSHIKI KAISHA TOSHIBA, Tokyo (JP)

(21) Appl. No.: 14/722,656

(22) Filed: May 27, 2015

(30) Foreign Application Priority Data
May 30, 2014 (JP) 2014-112519

(51) Int. Cl. H04N 13/04; G06K 9/00

(52) U.S. Cl. CPC H04N 13/0484; H04N 13/0409; G06K 9/0061

(57) ABSTRACT

According to one embodiment, an electronic apparatus includes a camera and a processor. The camera is configured to capture an image of eyes of a user. The processor is configured to detect a distance of the user's point of gaze by using the image captured by the camera, and to determine parallax to be applied to a pair of parallax images including a left-eye image and a right-eye image such that an image is displayed at a depth position corresponding to the detected distance of the user's point of gaze.

### CROSS-REFERENCE TO RELATED APPLICATIONS

This application is based upon and claims the benefit of priority from Japanese Patent Application No. 2014-112519, filed May 30, 2014, the entire contents of which are incorporated herein by reference.

### FIELD

Embodiments described herein relate generally to an electronic apparatus and a display processing method.

### BACKGROUND

In recent years, a device, which enables a stereoscopic image (a three-dimensional image) to be viewed by utilizing an illusion produced by a binocular parallax, and displaying a pair of images including a left-eye image and a right-eye image which are referred to as parallax images so that the displayed images are perceived sterically, has become available in the market.

Further, in accordance with the above development, methods for displaying an image referred to as an on-screen display (OSD) together with the main image without causing a sense of incongruity have been proposed variously.

An OSD makes the user feel uncomfortable when it is displayed in a state in which a depth position of the OSD does not conform to that of the main image. To put it short, a conventional method of displaying an OSD is to display the OSD at an appropriate depth position based on data for a stereoscopic image such as a value of the depth of the main image.

That is, in the conventional method of displaying an OSD, inputting data for the stereoscopic image is mandatory. In other words, unless the data for the stereoscopic image is input, it is not possible to display the OSD at an appropriate depth position with the conventional OSD-displaying method.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary illustration showing an appearance of an electronic apparatus of an embodiment.

FIG. 2 is an exemplary diagram showing a system configuration of the electronic apparatus of the embodiment.

FIG. 3 is an exemplary illustration showing an example of arranging an OSD on an image for either eye only when a stereoscopic image is to be perceived by use of parallax images (i.e., a left-eye image and a right-eye image).

FIG. 4 is an exemplary illustration showing an example of displaying the OSD without considering a depth position when a stereoscopic image is to be perceived by use of parallax images (i.e., a left-eye image and a right-eye image).

FIG. 5 is an exemplary illustration showing an example of displaying the OSD in consideration of a depth position when a stereoscopic image is to be perceived by use of parallax images (i.e., a left-eye image and a right-eye image).

FIG. 6 is an exemplary illustration showing the state in which the electronic apparatus of the present embodiment images the user's eyes.

FIG. 7 is an exemplary illustration showing how the eyes look (the state of the eyes) when a point of gaze is far away.

FIG. 8 is an exemplary illustration showing how the eyes look (the state of the eyes) when a point of gaze is near.

FIG. 9 is an exemplary illustration for describing a pupillary distance which is detected by the electronic apparatus of the embodiment.

FIG. 10 is an exemplary flowchart showing a procedure of OSD-display-processing in the electronic apparatus of the present embodiment.

### DETAILED DESCRIPTION

Various embodiments will be described hereinafter with reference to the accompanying drawings.

In general, according to one embodiment, an electronic apparatus includes a camera and a processor. The camera is configured to capture an image of eyes of a user. The processor is configured to detect a distance of the user's point of gaze by using the image captured by the camera, and to determine parallax to be applied to a pair of parallax images including a left-eye image and a right-eye image such that an image is displayed at a depth position corresponding to the detected distance of the user's point of gaze.

FIG. 1 is an exemplary illustration showing an appearance of an electronic apparatus 1 of the present embodiment. Here, it is assumed that the electronic apparatus 1 is realized as a spectacle-type display device.

The electronic apparatus 1, which is the spectacle-type display device, comprises temples 21, rims 22, a bridge 23, junctions 24 (which connect between the temples 21 and the rims 22, respectively), etc., which are components of the spectacles, as shown in FIG. 1. In the rims 22, lenses-cum-screens 11a and 11b are embedded, respectively. also, projectors 12a and 12b for projecting parallax images (a left-eye image a1 and a right-eye image a2) on the lenses-cum-screens 11a and 11b are arranged in the junctions 24, respectively. Further, in the rims 22, cameras 13a and 13b for imaging the eyes of a user wearing the electronic apparatus 1 are arranged, respectively. The images captured by the cameras 13a and 13b are guided within the junctions 24 via transmission paths 14a and 14b, respectively. A processor which manages operation control of the electronic apparatus 1, a battery which supplies power for operating the electronic apparatus 1, and the like, are arranged inside the junctions 24, although FIG. 1 does not illustrate this. While it is assumed here that the parallax images (the left-eye image a1 and the right-eye image a2) are projected on the lenses-cum-screens 11a and 11b by the projectors 12a and 12b, respectively, a device for displaying the parallax images (the left-eye image a1 and the right-eye image a2) on the lenses-cum-screens 11a and 11b is not limited to the projectors 12a and 12b.

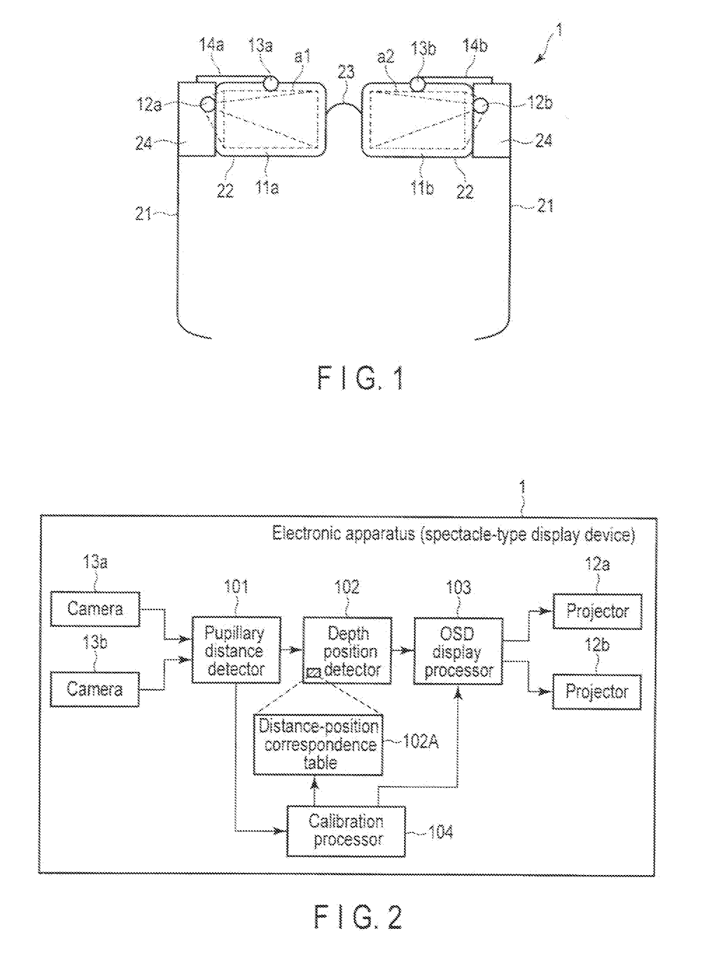

FIG. 2 is an exemplary diagram showing a system configuration of the electronic apparatus 1 of the embodiment.

Apart from the aforementioned projectors 12a and 12b, and the cameras 13a and 13b, the electronic apparatus 1 comprises a pupillary distance detector 101, a depth position detector 102, an OSD display processor 103, and a calibration processor 104, as shown in FIG. 2. These components are realized by software executed by the processor described above, for example. Note that the electronic apparatus 1 may be constituted of two unit, i.e., a first unit which is attached to the user and a second unit which is separated from the first unit, and the pupillary distance detector 101, the depth position detector 102, the OSD display processor 103, and the calibration processor 104 as shown in FIG. 2, may be mounted in the second unit separated from the first unit that is attached to the user. The first unit and the second unit transmit and receive necessary information by way of wireless communication, for example.

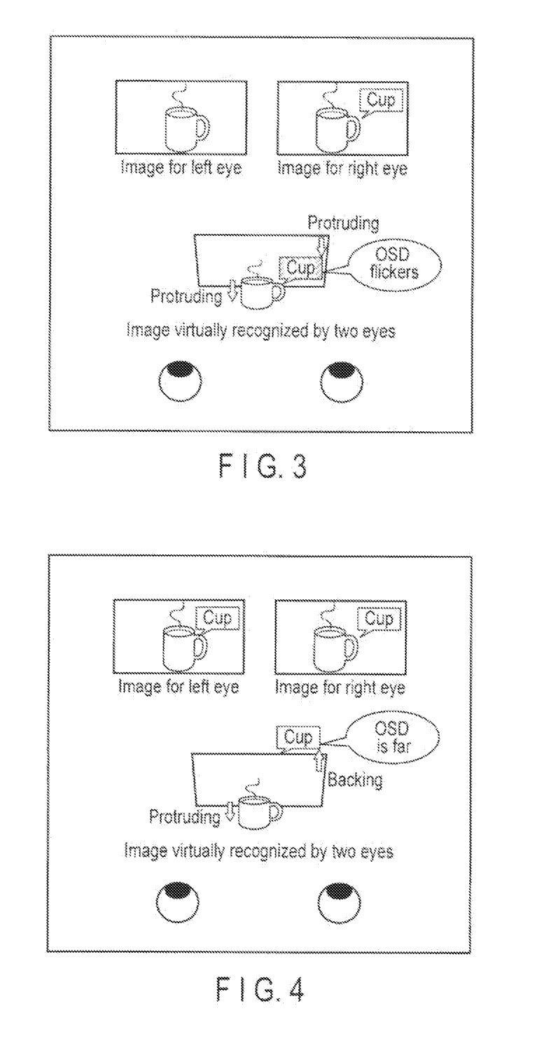

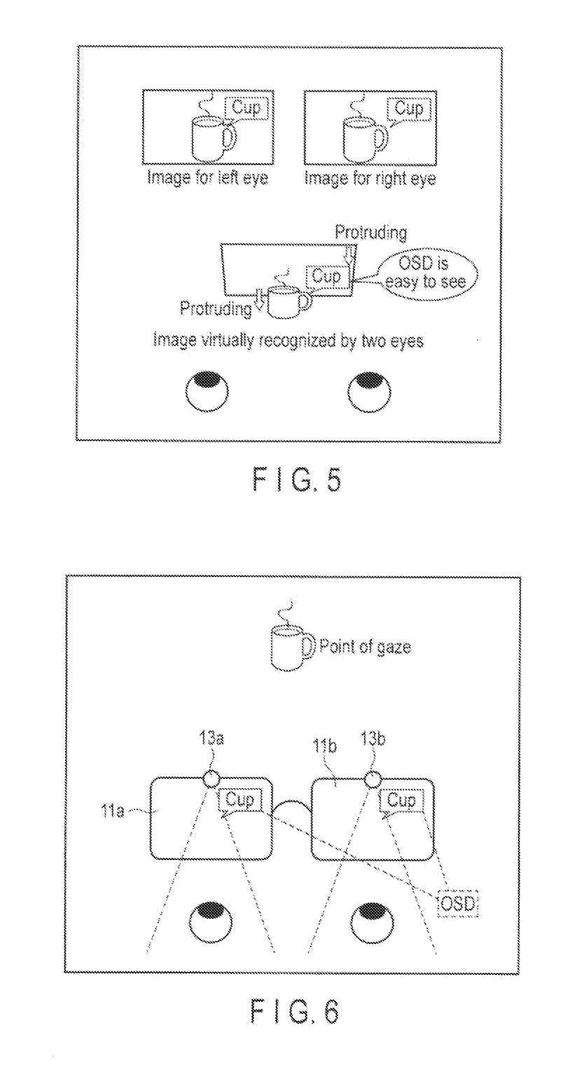

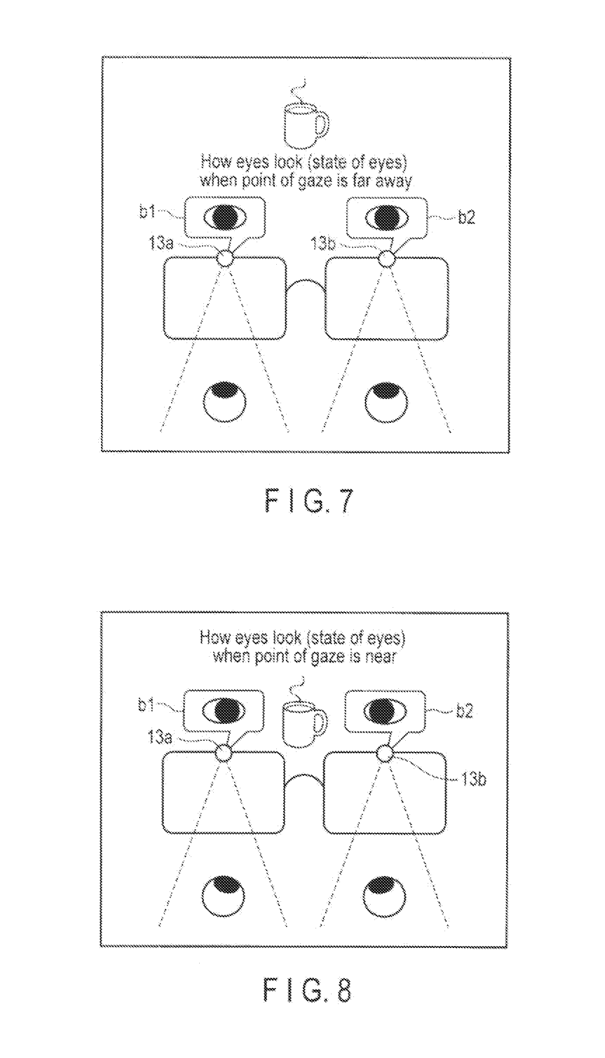

By referring to FIG. 3, FIG. 4, FIG. 5, FIG. 6, FIG. 7 and FIG. 8, the principle of operation regarding display of an OSD in the electronic apparatus 1 will now be described.

FIG. 3 is an exemplary illustration showing an example of arranging an OSD on an image for either eye only when a stereoscopic image is to be perceived by use of parallax images (the left-eye image and the right-eye image).

As shown in FIG. 3, when the OSD is arranged on, for example, only the right-eye image, the OSD is seen in a flickering way by the user.

Further, FIG. 4 is an exemplary illustration showing an example of displaying the OSD without considering the depth position when a stereoscopic image is to be perceived by use of parallax images (the left-eye image and the right-eye image).

As shown in FIG. 4, even if the OSD is arranged on both of the left-eye image and the right-eye image, unless the depth position is considered, the user feels uncomfortable because of a misalignment between the OSD and the main image in the depth direction.

Furthermore, FIG. 5 is an exemplary illustration showing an example of displaying the OSD in consideration of the depth position when a stereoscopic image is to be perceived by use of parallax images (the left-eye image and the right-eye image).

As shown in FIG. 5, when the OSD is arranged on both of the left-eye image and the right-eye image, by considering the depth position, the OSD becomes easy to see by the user and will not make the user feel uncomfortable.

Incidentally, each of FIG. 3, FIG. 4 and FIG. 5 assumes the case where the OSD is displayed to the user who perceives the stereoscopic image by use of parallax images (the left-eye image and the right-eye image). Meanwhile, in the electronic apparatus 1, which is the spectacle-type display device, a usage scene in which an OSD is displayed to the user who is looking at an object in real space (i.e., the user wearing the electronic apparatus 1) is also possible. In this case, a conventional OSD-displaying method, which is to display an OSD at an appropriate depth position on the basis of data for a stereoscopic image such as a value of the depth of the main image, cannot be applied. Hence, the electronic apparatus 1 enabled the OSD to be displayed at an appropriate depth position on the basis of the state of the user's eyes. Further, needless to say, the method of displaying an OSD of the electronic apparatus 1 in which the OSD is displayed at an appropriate depth position on the basis of the state of the user's eyes is also applicable to the case of displaying an OSD to the user who perceives a stereoscopic image by use of parallax images (the left-eye image and the right-eye image).

As shown in FIG. 6, the electronic apparatus 1 images the eyes of the user who is gazing at an object in real space via the lenses-cum-screens 11a and 11b, for example, by use of the cameras 13a and 13b. FIG. 7 is an exemplary illustration showing how the eyes look (the state of the eyes) when a point of gaze is far away, and FIG. 8 is an exemplary illustration showing how the eyes look (the state of the eyes) when a point of gaze is near.

When the point of gaze is far away, since an intersection of the lines of sight is far away, a distance between the portions of the eyes including the irises and pupils (the irises), or more specifically, the pupils, is increased. Accordingly, images b1 and b2 captured by the cameras 13a and 13b will be those as shown in FIG. 7, for example.

Meanwhile, when the point of gaze is near, since an intersection of the lines of sight is near, a distance between the portions of the eyes including the irises and pupils (the irises), or more specifically, the pupils, is reduced. Accordingly, images b1 and b2 captured by the cameras 13a and 13b will be those as shown in FIG. 8, for example.

The electronic apparatus 1 first detects a distance between the pupils (i.e., a pupillary distance) by using the images b1 and b2 captured by the cameras 13a and 13b, and detects a distance of the point of gaze based on the detected pupillary distance. Further, the electronic apparatus 1 displays an OSD at a depth position corresponding to the distance of the point of gaze which has been detected. This is, parallax to be applied to parallax images for OSD is determined.

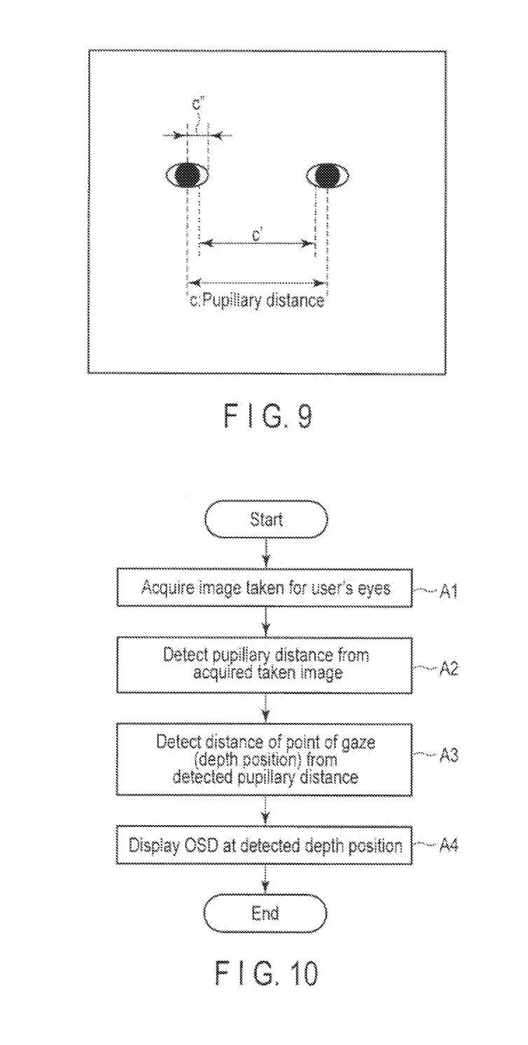

Here, the pupillary distance refers to distance c as shown in FIG. 9, but is not limited to distance c as a value for detecting the state of the user's eyes. That is, various values such as the shortest distance c′ between the portions of the eyes including the irises and pupils (the irises) or distance c″ from the pupil to the inner corner of the eye may be adopted as long as it takes on a value which changes by the distance of the intersection of the lines of sight.

FIG. 2 will be referred to again.

The images captured by the cameras 13a and 13b are input to the pupillary distance detector 101. The pupillary distance detector 101 performs various kinds of image processing including synthesis processing and recognition processing for the images captured by the cameras 13a and 13b, and detects a pupillary distance. The pupillary distance detector 101 transfers the detected pupillary distance to the depth position detector 102.

The depth position detector 102 comprises a distance-position correspondence table 102A in which the corresponding relationship between the pupillary distance and the distance of the point of gaze (depth position) is recorded. When the depth position detector 102 receives the pupillary distance from the pupillary distance detector 101, the depth position detector 102 refers to the distance-position correspondence table 102A and detects a depth position corresponding to the pupillary distance. In other words, the depth position detector 102 determines parallax to be applied to the parallax images (the left-eye image and the right-eye image) for OSD. The depth position detector 102 transfers the detected depth position to the OSD display processor 103.

The OSD display processor 103 generates parallax images (a left-eye image and a right-eye image) for OSD so that an OSD is displayed at the depth position received from the depth position detector 102, and projects those images on the lenses-cum-screens 11a and 11b by the projectors 12a and 12b.

In this way, for example, the OSD can be displayed at an appropriate depth position to a user who is gazing at an object in real space via the lenses-cum-screens 11a and 11b, that is, without needing to input data for the stereoscopic image.

Further, the calibration processor 104 is a module which manages processing of adjusting, for the user, the distance-position correspondence table 102A in which the corresponding relationship between the pupillary distance and the distance of the point of gaze (depth position) is recorded when the user uses the electronic apparatus 1 for the first time or at an arbitrary timing. The calibration processor 104 causes, for example, a stereoscopic image as virtually recognized at the far end (at infinity) to be displayed by the OSD display processor 103 first, and acquires the pupillary distance at that time from the pupillary distance detector 101. Next, the calibration processor 104 causes a stereoscopic image as virtually recognized in proximity to be displayed by the OSD display processor 103, and acquires the pupillary distance at that time from the pupillary distance detector 101. In this way, the calibration processor 104 acquires the states of the eyes when the user gazes at objects at different distances, more specifically, the pupillary distances, as sample values. Further, the calibration processor 104 adjusts the distance-position correspondence table 102A for the user in question on the basis of these sample values. Note that the sample values can be acquired by, for example, voice guidance, to instruct the user to look at a remote place first and then to look at a near place, instead of displaying a stereoscopic image for guiding the user's gaze.

FIG. 10 is an exemplary flowchart showing a procedure of OSD-display-processing in the electronic apparatus 1.

Firstly, the electronic apparatus 1 images the user's eyes by the cameras 13a and 13b (block A1). The pupillary distance detector 101 detects a pupillary distance by using the images captured by the cameras 13a and 13b (block A2).

Also, the depth position detector 102 receives the pupillary distance detected by the pupillary distance detector 101, and determines a distance of a point of gaze (depth position) by referring to the distance-position correspondence table 102A (block A3). Further, the OSD display processor 103 displays an OSD at the depth position detected by the depth position detector 102 (block A4).

As can be seen, according to the electronic apparatus 1, it becomes possible to, for example, display an OSD at an appropriate depth position without needing to input data for a stereoscopic image.

In the above, it has been described that the electronic apparatus 1 is realized as a spectacle-type display device. However, the method of displaying an OSD at an appropriate depth position on the basis of the state of the user's eyes may be applied to various devices such as a television, a display, and a monitor capable of displaying a stereoscopic image, for example, not limited to the spectacle-type display device. If the aforementioned devices are used, since it is assumed that there will be enough space between the device and the user, only one camera will suffice to image the user's eyes. As a matter of course, even in the spectacle-type display device, one camera alone may realize the above-described feature depending on the capability of the camera.

Also, various applications are possible for the method of displaying an OSD at an appropriate depth position on the basis of the state of the user's eyes. For example, when a distance of the point of gaze detected from the state of the user's eyes is deviated from a distance of a point at which the user should have been gazing at that time by a predetermined value or more, a warning can be given to the user by an OSD or voice guidance, etc.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is a claimed is:

1. An electronic apparatus comprising:
a camera configured to capture an image of eyes of a user; and
a processor configured to:
detect a distance of the user's point of gaze by using the image captured by the camera; and
determine parallax to be applied to a pair of parallax images comprising a left-eye image and a right-eye image such that an image is displayed at a depth position corresponding to the detected distance of the user's point of gaze.

2. The apparatus of claim 1, wherein the processor is configured to detect a pupillary distance from the captured image, and to detect the distance of the user's point of gaze based on the pupillary distance.

3. The apparatus of claim 2, wherein the processor is configured to adjust correspondence between the pupillary distance and the distance of the user's point of gaze.

4. The apparatus of claim 3, wherein the processor is configured to acquire two or more images captured by causing the user to gaze at objects at two or more different distances, and to adjust the correspondence between the pupillary distance and the distance of the user's point of gaze.

5. The apparatus of claim 1, further comprising:
a left-eye lens-cum-screen;
a right-eye lens-cum-screen;
a left-eye projector configured to project the left-eye image on the left-eye lens-cum-screen; and
a right-eye projector configured to project the right-eye image on the right-eye lens-cum-screen.

6. The apparatus of claim 5, further comprising a first unit and a second unit comprising communication functions, respectively, wherein;
the camera, the left-eye lens-cum-screen, the right-eye lens-cum-screen, the left-eye projector, and the right-eye projector are provided in the first unit; and
the processor is provided in the second unit.

7. An electronic apparatus comprising:
a camera configured to capture an image or eyes of a user;
a processor configured to:
detect a distance of the user's point of gaze by using the image captured by the camera; and
give a warning to the user when the detected distance of the user's point of gaze is deviated from a presumed distance by a first value or more.

8. A display processing method of an electronic apparatus comprising:
capturing an image of eyes of a user;
detecting a distance of the user's point of gaze by using the captured image; and
determining parallax to be applied to a pair of parallax images comprising a left-eye image and a right-eye image such that an image is displayed at a depth position corresponding to the distance of the user's point of gaze which is detected.

9. The method of claim 8, wherein the detecting comprises detecting a pupillary distance from the captured image, and detecting the distance of the user's point of gaze based on the pupillary distance.

10. The method of claim 9, further comprising adjusting correspondence between the pupillary distance and the distance of the user's point of gaze.

11. The method of claim 10, wherein the adjusting comprises acquiring two or more images captured by causing the user to gaze at objects at two or more different distances, and adjusting the correspondence between the pupillary distance and the distance of the user's point of gaze.
